(19) United States
(12) Patent Application Publication
(10) Pub. No.: US 2013/0227157 A1
(43) Pub. Date: Aug. 29, 2013

(54) TERMINAL APPARATUS, OPERATION METHOD OF TERMINAL APPARATUS, AND PROGRAM PRODUCT

(71) Applicant: Yasuyuki TANAKA, Chigasaki-shi (JP)

(72) Inventor: Yasuyuki TANAKA, Chigasaki-shi (JP)

(73) Assignee: KABUSHIKI KAISHA TOSHIBA, Tokyo (JP)

(21) Appl. No.: 13/723,343

(22) Filed: Dec. 21, 2012

(30) Foreign Application Priority Data
Feb. 29, 2012 (JP) 2012-044371

(51) Int. Cl. H04L 29/06

(52) U.S. Cl. CPC H04L 63/08
USPC 709/229

(57) ABSTRACT

According to one embodiment, a terminal apparatus includes a first processing unit, second processing unit, and determiner. The first processing unit is configured to execute message processing as an authentication client for network access authentication. The second processing unit is configured to execute message processing as an authentication relay between a network access authentication server and an authentication client in another terminal apparatus. The determiner is configured to choose one of the first processing unit and the second processing unit on how to process a message which is sent by the network access authentication server or the other terminal apparatus.

### CROSS-REFERENCE TO RELATED APPLICATIONS

This application is based upon and claims the benefit of priority from Japanese Patent Application No. 2012-044371, filed Feb. 29, 2012, the entire contents of which are incorporated herein by reference.

### FIELD

Embodiments described herein relate generally to a terminal apparatus which executes network access authentication, an operation method of the terminal apparatus, and a program product.

### BACKGROUND

In network access authentication, a network side authenticates a communication node (terminal apparatus) so as to connect only an authentic communication node to the network. On the other hand, the communication node side authenticates the network so as to be connected to only the authentic network.

RFC6345 specifies the authentication relay specifications which intervene authentication processing between an authentication client and authentication server.

### BRIEF DESCRIPTION OF THE DRAWINGS

FIG. 1 is a diagram showing the network configuration according to the first embodiment;

FIG. 2 is a message sequence chart showing one mode of network access authentication;

FIG. 3 is a message sequence chart showing another mode of network access authentication;

FIG. 4 is a flowchart showing the received message processing sequence;

FIG. 5 is a block diagram showing the arrangement of a communication node;

FIG. 6 is a message sequence chart of network access authentication according to the second embodiment;

FIG. 7 is a flowchart showing the received message processing sequence according to the third embodiment;

FIG. 8 is a flowchart showing the received message processing sequence according to the fourth embodiment; and

FIG. 9 is a flowchart showing the received message processing sequence according to the fifth embodiment.

### DETAILED DESCRIPTION

In general, according to one embodiment, a terminal apparatus includes a first processing unit, second processing unit, and determiner. The first processing unit is configured to execute message processing as an authentication client for network access authentication. The second processing unit is configured to execute message processing as an authentication relay between a network access authentication server and an authentication client in another terminal apparatus. The determiner is configured to choose one of the first processing unit and the second processing unit on how to process a message which is sent by the network access authentication server or the other terminal apparatus.

Embodiments will be described hereinafter with reference to the drawings.

### First Embodiment

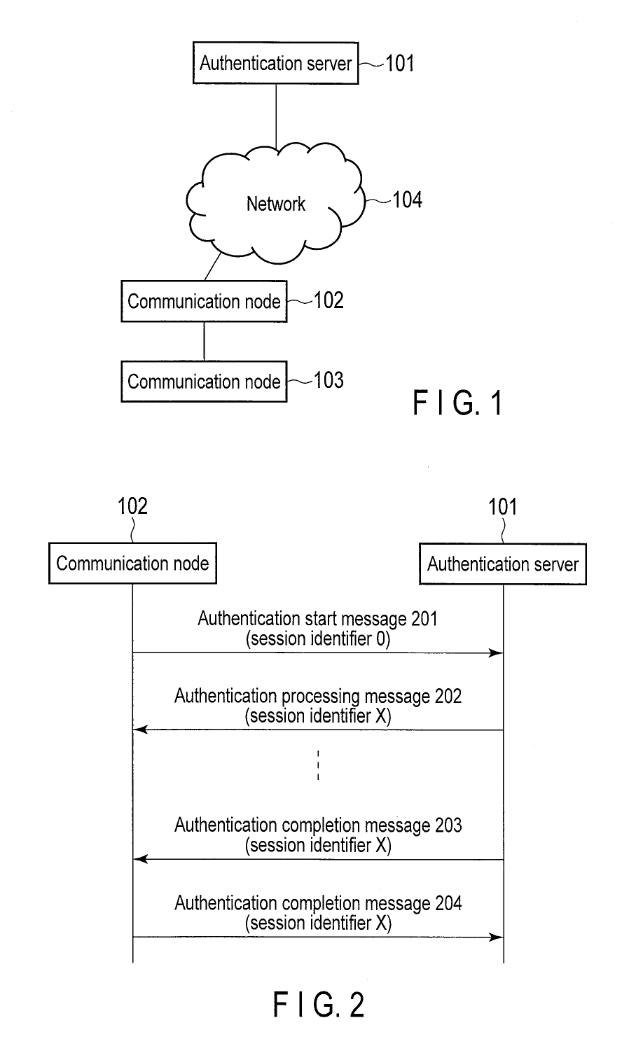

FIG. 1 shows the network configuration according to the first embodiment. A network access authentication server (to be referred to as “authentication server” hereinafter) 101 and communication node 102 are connected to a network 104. A communication node 103 is connected to the network 104 via the communication node 102. To the network 104, communication nodes, which are not shown in FIG. 1, are also connected. When the communication node 102 establishes connection to the network 104, network access authentication processing is executed between the authentication server 101 and communication node 102. The communication node 102 cannot establish connection to the network 104 unless the network access authentication succeeds.

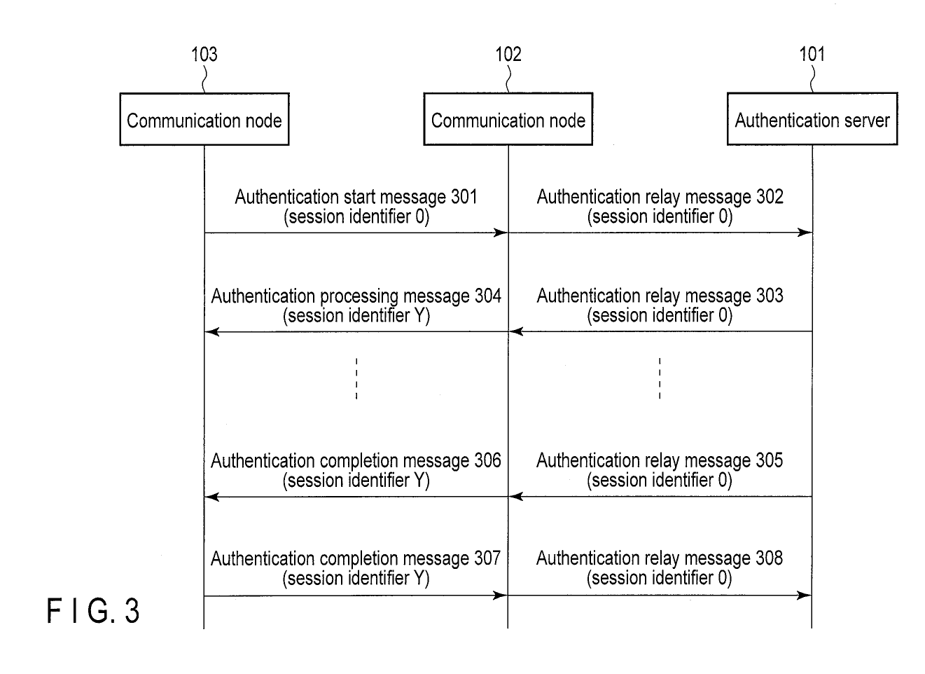

FIG. 2 shows a message sequence of the network access authentication processing between the authentication server 101 and communication node 102. Initially, the communication node 102 transmits an authentication start message 201 to the authentication server 101, thus starting the network access authentication processing. Upon reception of the authentication start message 201, the authentication server 101 transmits an authentication processing message 202 to the communication node 102. Lastly, authentication completion messages 203 and 204 are exchanged, thus completing the network access authentication processing between the authentication server 101 and communication node 102.

The communication node 102 and authentication server 101 manage an authentication state as a session. The session is established between the communication node 102 and authentication server 101 at the beginning of the network access authentication processing, and is maintained until the authentication fails or a validity period is expired. The communication node 102 and authentication server 101 respectively manage session information as information associated with the already established session. The session information includes a session identifier used to identify the session, validity period (lifetime), addresses of the authentication client and server, a session state, and the like. The session state indicates a current state associated with the network access processing such as a state immediately after transmission of the authentication start message, that during network access authentication, that after completion of network access authentication, that during network access re-authentication, and the like. The session identifier is a positive integer, and a value “0” is also valid. The authentication server, which received the authentication start message, determines a session identifier, and notifies the authentication client of the session identifier using the immediately preceding authentication processing message. All the messages used in the authentication processing have the session identifier indicating a session to which the messages correspond.

At a timing of the authentication start message 201 in FIG. 2, since a session identifier is not settled, the authentication start message 201 is transmitted while setting “0” in its session identifier. Upon reception of the authentication start message 201, the authentication server 101 determines a session identifier X of a session to be established between itself and the communication node 102. For this reason, the authentication processing message 202 has the session identifier X determined by the authentication server 101.

In this manner, the communication node 102 operates as an authentication client when it establishes connection to the network 104. Then, the network access authentication processing between the communication node 102 and authentication server 101 is executed. Note that the network access authentication state has a validity period, and re-authentication processing is often executed before the validity period is expired. At the time of the re-authentication processing, the communication node 102 also operates as an authentication client. In addition, when the communication node 102 makes a communication associated with its own session, it operates as an authentication client.

When the communication node 103 establishes connection to the network 104 via the communication node 102, network access authentication processing has to be executed between the authentication server 101 and communication node 103, and this authentication has to succeed. At this time, the communication node 102 operates as an authentication relay, and relays messages between the authentication server 101 and communication node 103.

FIG. 3 shows a message sequence of the network access authentication processing between the authentication server 101 and communication node 103. Initially, the communication node 103 transmits an authentication start message 301 to the communication node 102, thus starting the network access authentication processing. The communication node 102 generates an authentication relay message 302 including the received authentication start message 301, and transmits the generated message 302 to the authentication server 101. A session identifier of the authentication relay message 302 is “0”. Upon reception of the authentication relay message 302, the authentication server 101 extracts the authentication start message 301 from this authentication relay message 302, and determines a session identifier Y of a session to be established between itself and the communication node 103. Then, the authentication server 101 transmits an authentication relay message 303 including an authentication processing message 304 having the session identifier Y to the communication node 102. A session identifier of this authentication relay message 303 is “0”. Upon reception of the authentication relay message 303, the communication node 102 extracts the authentication processing message 304 from the authentication relay message 303, and transmits the authentication processing message 304 to the communication node 103. Lastly, authentication completion messages 306 and 307 are exchanged, thus completing the network access authentication processing between the authentication server 101 and communication node 103. As described above with reference to FIG. 3, the communication node 102 operates as an authentication relay. That is, the communication node 102 transmits messages (301, 307, etc.) from the communication node 103 to the authentication server 101 to the authentication server 101 in place of the communication node 103. The communication node 102 also transmits messages (304, 306, etc.) from the authentication server 101 to the communication node 103 to the communication node 103 in place of the authentication server 101.

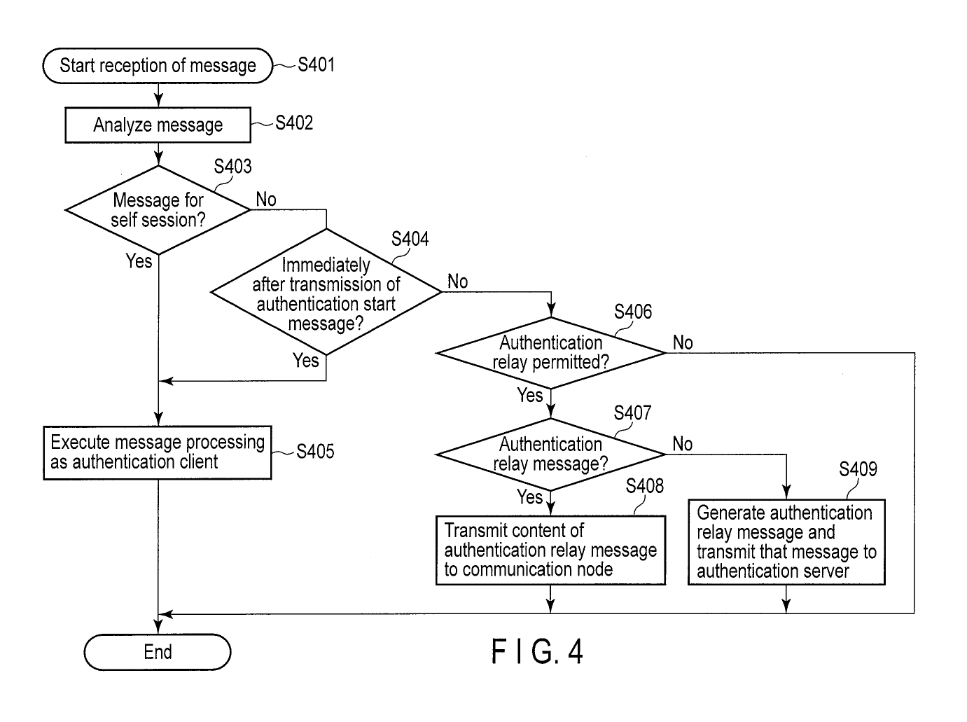

FIG. 4 shows the received message processing sequence by the communication node 102 according to the first embodiment. In this embodiment, the communication node 102 can operate as an authentication client, as shown in FIG. 2, and as an authentication relay, as shown in FIG. 3. The former operation is related to network access authentication of the communication node 102 itself, and the latter operation is related to network access authentication of another communication node (in this example, the communication node 103) as an authentication relay target of the communication node 102. In either operation, the communication node 102 has to appropriately process messages received from the authentication server 101 or the other communication node as the authentication relay target, and FIG. 4 shows an example of such processing. Upon reception of a message (S401), the communication node 102 analyzes this received message (S402), and extracts a session identifier.

Then, the communication node 102 checks whether or not that session identifier corresponds to a session between the communication node 102 and authentication server 101 (S403). If this session identifier corresponds to the session between the communication node 102 and authentication server 101, that received message is a message for the session of itself, that is, the communication node 102. If the session identifier of the received message does not correspond to the session between the communication node 102 and authentication server 101, the communication node 102 further checks whether or not a session state is that immediately after transmission of the authentication start message or not (S404). The state immediately after transmission of the authentication start message indicates a state from when the authentication start message 201 in FIG. 2 is transmitted until the authentication processing message 202 is received. Whether or not the session state is that immediately after transmission of the authentication start message can be determined when the communication node 102 refers to a session state included in session information managed by itself. Even when the session identifier of the received message does not correspond to the session between the communication node 102 and authentication server 101, if the session state is that immediately after transmission of the authentication start message, the process advances to step S405.

If the received message is a message for the session of the communication node 102 itself, and if the session state is that immediately after transmission of the authentication start message although that received message is not a message for the session of the communication node 102 itself, the communication node 102 processes that received message as an authentication client (S405).

On the other hand, if the session identifier of the received message does not correspond to the session between the communication node 102 and authentication server 101 and if the session state of the communication node 102 is not the state immediately after transmission of the authentication start message, the control enters authentication relay processing.

In the authentication relay processing, the communication node 102 checks whether or not an authentication relay is permitted (S406). If the authentication relay is permitted, the communication node 102 checks whether or not the received message is an authentication relay message (S407). Since each message includes a message type indicating an authentication start message, authentication processing message, authentication relay message, or the like, the communication node 102 can check whether or not the received message is an authentication relay message with reference to that information. If the received message is an authentication relay message, the communication node 102 extracts an authentication processing message or the like included in the authentication relay message, and transmits the extracted message to the communication node 103 (S408).

If the received message is not an authentication relay message, the communication node 102 generates an authentication relay message including the received message, and transmits the generated message to the authentication server 101 (S409).

As for permission/inhibition of the authentication relay, that is, feasibility of an authentication relay function, for example, only when the network access authentication of the communication node 102 has succeeded, and the session state becomes a connection permitted state, the authentication relay function may be enabled. When the address of the authentication server 101 is unknown, the authentication relay function may be disabled.

As a message having a session identifier=0, the authentication start message and authentication relay message are assumed. When a session identifier of a session which is established between the authentication server 101 and authentication client is “0”, the authentication processing message, authentication completion message, and the like, which are associated with that session, also include a session identifier=0. In the first embodiment, in consideration of a case in which the session identifier of the session established between the communication node 102 and authentication server 101 is “0”, an authentication relay message which is to be originally processed in step S409 is determined as a message for the self session, and may often be processed in step S405. This means that the communication node 102 executes reception processing as a message to the communication node 102 itself without relaying the message to be relayed.

In order to avoid such situation, when the authentication server 101 selects a session identifier=0 as that of a session between itself and the communication node 102, the communication node 102 may discard that session, and may transmit an authentication start message again to re-establish a session. In this embodiment, this series of processes may or may not be executed. When the series of processes are executed, such processes are included as the processing (S405) of the authentication client.

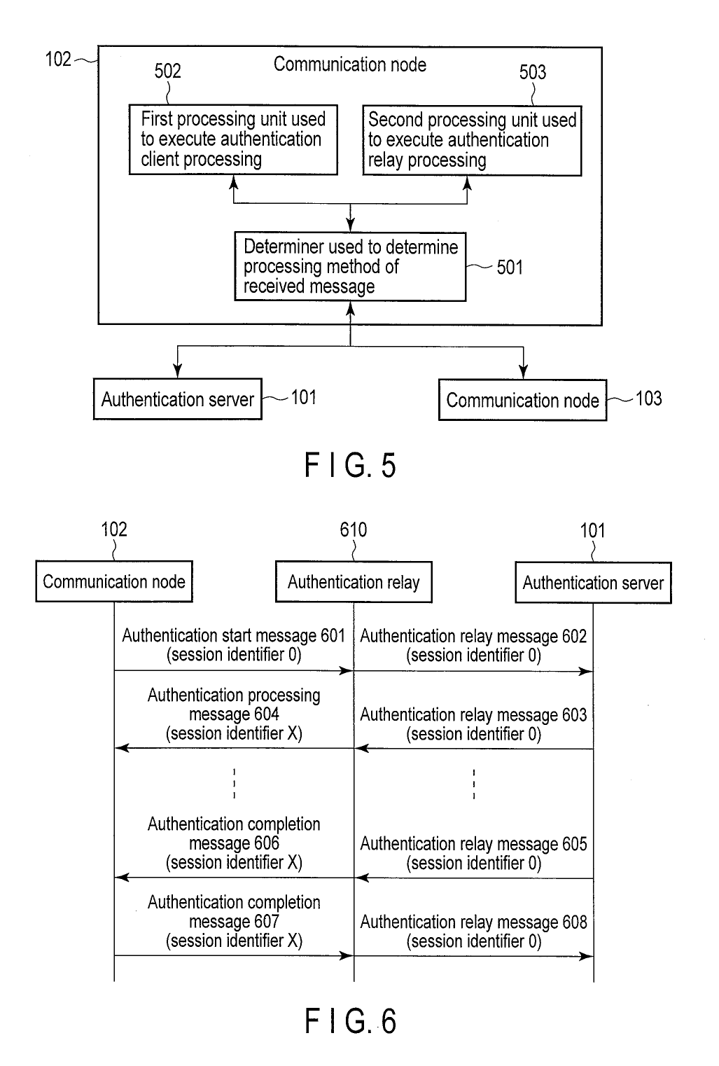

FIG. 5 shows the arrangement of the communication node 102. The communication node 102 includes a determiner 501 which determines a processing method of a received message, a first processing unit 502 which executes authentication client processing, and a second processing unit 503 which executes authentication relay processing. The determiner 501, which determines the processing method of a received message, mainly executes the processes in steps S402, S403, S404, and S406 shown in FIG. 4. The authentication client processing unit 502 mainly executes the process in step S405. The authentication relay processing unit 503 mainly executes the processes in steps S407, S408, and S409. Although not shown in FIG. 5, the communication node 102 includes hardware components such as a CPU, memory, communication interface, and the like, which are required to operate as a communication node, and software such as an operating system, communication stack software, and the like.

As will be understood by those who are skilled in the art, the aforementioned embodiment can be an embodiment in which a network access authentication protocol is compliant with RFC5191 (PANA), and the operation of the authentication relay is compliant with RFC6345. Note that the protocol and communication method to be applied are not limited to them. The same applies to the second and subsequent embodiments to be described later.

According to the aforementioned embodiment, a single communication node (terminal apparatus) can function as an authentication client and also as an authentication relay, and can appropriately process messages received in the process of the network access authentication. Such communication node can be implemented without changing existing communication specifications.

### Second Embodiment

In the second embodiment, a mode of network access authentication processing of the communication node 102 is different from that shown in FIG. 2 in the first embodiment. FIG. 6 shows a message sequence of the network access authentication of the communication node 102 according to the second embodiment. In the first embodiment, the communication node 102 directly executes the network access authentication processing between itself and the authentication server 101. By contrast, the communication node 102 of the second embodiment executes the network access authentication processing between itself and the authentication server 101 via an authentication relay 610 connected to the network 104.

Even the communication node 102, which executes the network access authentication via the authentication relay 610 connected to the network 104, can be configured to function as an authentication client and also as an authentication relay as in the first embodiment, and can appropriately process messages received in the process of the network access authentication.

### Third Embodiment

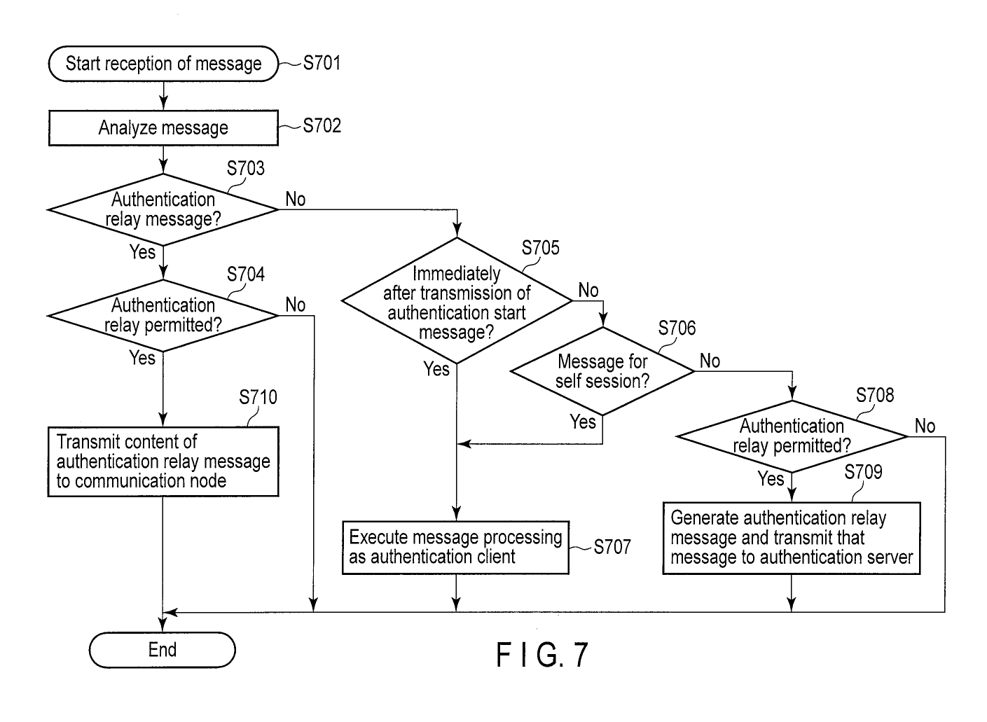

The third embodiment is different from the processing sequence shown in FIG. 4 of the first embodiment in that when the communication node 102 receives a message, it checks first whether or not that message is an authentication relay message. FIG. 7 shows the received message processing sequence of the communication node 102 according to the third embodiment.

Upon reception of a message (S701), the communication node 102 analyzes this received message (S702), and checks whether or not this message is an authentication relay message (S703). If the received message is an authentication relay message, the communication node 102 checks if the authentication relay is permitted (S704). Whether or not the authentication relay is permitted may be determined by the method described in the first embodiment. If the authentication relay is permitted, the communication node 102 extracts an authentication processing message or the like included in the authentication relay message, and transmits the extracted message to the communication node 103 (S710).

If it is determined in step S703 that the received message is not an authentication relay message, the communication node 102 checks if a session state is that immediately after transmission of an authentication start message (S705). Also, the communication node 102 checks based on a session identifier of the received message whether or not the received message is a message for a session of the communication node 102 itself (S706). If the session state is that immediately after transmission of the authentication start message or if the received message is a message for a session of the communication node 102 itself, the communication node 102 executes message processing as an authentication client (S707).

If the received message is not a message for a session of the communication node 102 itself, the communication node 102 checks whether or not the authentication relay is permitted (S708). If the authentication relay is permitted, the communication node 102 generates an authentication relay message including the received message, and transmits the generated message to the authentication server 101 (S709).

As described above, the third embodiment is different from the first embodiment only in that whether or not the received message is an authentication relay message is checked and processed first, and the same effects as in the first embodiment can be obtained.

### Fourth Embodiment

The fourth embodiment is different from the aforementioned first embodiment (FIG. 4) in operations executed when the communication node 102 receives a message.

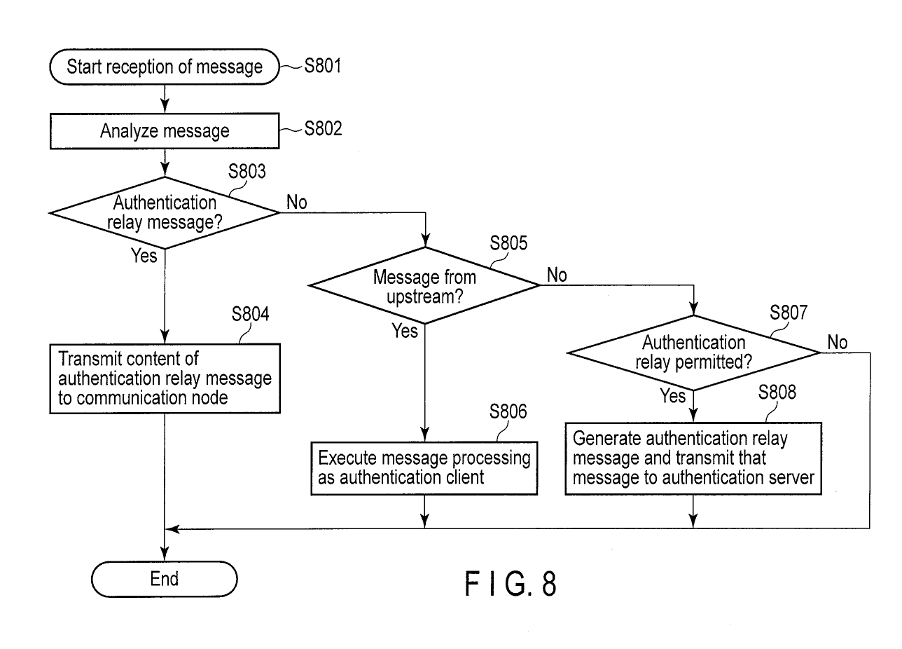

FIG. 8 shows the received message processing sequence of the communication node 102 according to the fourth embodiment. Upon reception of a message (S801), the communication node 102 analyzes this received message (S802), and checks whether or not this message is an authentication relay message (S803). If the received message is an authentication relay message, the communication node 102 extracts an authentication processing message or the like included in the authentication relay message, and transmits the extracted message to the communication node 103.

If the received message is not an authentication relay message, the communication node 102 checks whether the received message is transmitted from the upstream or downstream side of the network (S805). If the received message is transmitted from the upstream side, for example, if it is transmitted via the network 104, the communication node 102 executes message processing as an authentication client (S806). Note that a communication link in a direction to be closer to the authentication server 101 will be referred to as “upstream”, and that in a direction to be apart from the authentication server 101 will be referred to as “downstream” hereinafter.

If the received message is transmitted from the downstream side, for example, if it is transmitted from the communication node 103, the communication node 102 checks whether or not the authentication relay is permitted (S807). If the authentication relay is permitted, the communication node 102 generates an authentication relay message including the received message and transmits the generated message to the authentication server 101 (S809). Whether or not the authentication relay is permitted may be determined by the method described in the first embodiment.

Whether or not the received message is a message coming from the upstream side can be discriminated in step S805 when a destination address or destination port number of the received message is different. Typically, when an upstream network interface and downstream network interface are different, the discrimination in step S805 is allowed. However, the present embodiment is not limited to this.

### Fifth Embodiment

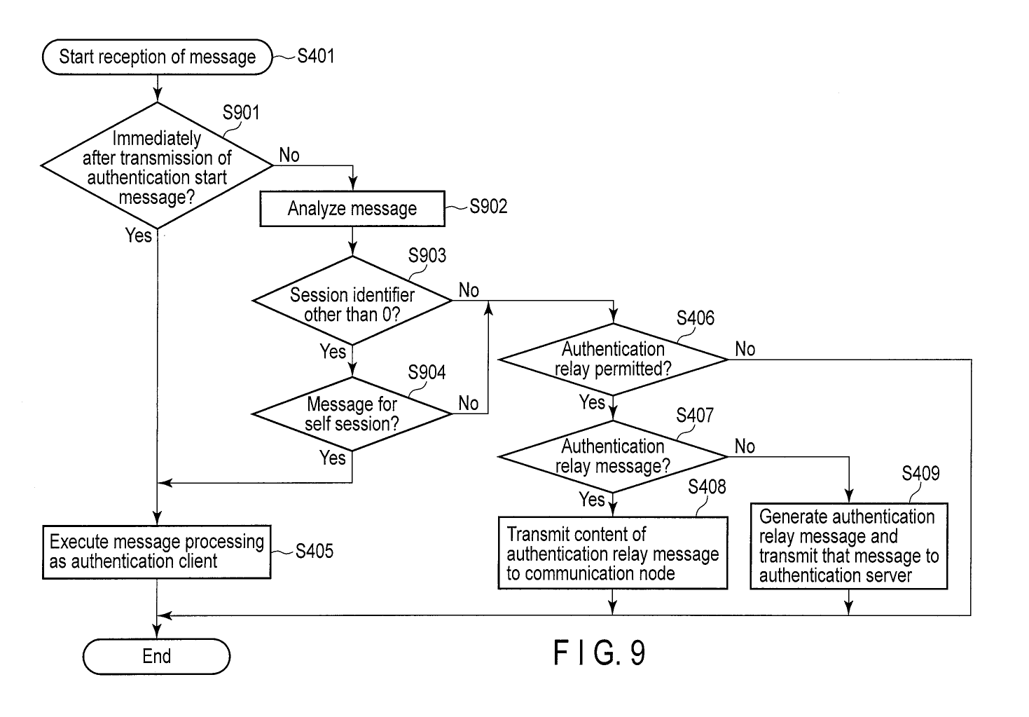

The fifth embodiment is different from the aforementioned first embodiment (FIG. 4) in operations executed when the communication node 102 receives a message. More specifically, the fifth embodiment is different from the first embodiment in that it includes processing for checking whether or not a session identifier is other than “0”. FIG. 9 shows the received message processing sequence of the communication node 102 according to the fifth embodiment.

Upon reception of a message (S401), the communication node 102 checks whether or not a session state is that immediately after transmission of an authentication start message (S901). Whether or not the session state is that immediately after transmission of an authentication start message may be checked by the method described in the first embodiment. If the session state is that immediately after transmission of an authentication start message, the communication node 102 executes message processing as an authentication client (S405).

If the session state is not that immediately after transmission of an authentication start message, the communication node 102 analyzes the message (S902), and checks whether or not a session identifier is other than “0” (S903). If the session identifier is other than “0”, the communication node 102 checks whether or not the received message is a message for a session of the communication node 102 itself (S904). As a result, if the received message is a message for a session of the communication node 102 itself, the communication node 102 executes step S405.

If the session identifier is “0” or if the received message is not a message for a session of the communication node 102 itself, the communication node 102 executes processes in step S406 and subsequent steps.

According to the aforementioned embodiments, both an authentication client function and authentication relay function associated with network access authentication can be implemented on a single communication node. Such communication node can be implemented without changing existing communication specifications.

For example, in a configuration in which a large number of smart meters are connected to a concentrator, a large number of such concentrators configure a wireless mesh network, and they are connected to a head end of an electric power company via a backhaul network, the network access authentication can be executed when the concentrators configure the wireless mesh network and when each smart meter establishes connection to the wireless mesh network. The aforementioned embodiments are applicable to the concentrators and smart meters in this case.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A terminal apparatus comprising:
a first processing unit configured to execute message processing as an authentication client for network access authentication;
a second processing unit configured to execute message processing as an authentication relay between a network access authentication server and an authentication client in another terminal apparatus; and
a determiner configured to choose one of the first processing unit and the second processing unit on how to process a message which is sent by the network access authentication server or the other terminal apparatus.

2. The apparatus according to claim 1, wherein the first processing unit holds information indicating a network access authentication state, and
the determiner determines based on the information and an analysis result of a message received from the network access authentication server or the other terminal apparatus whether the message is processed by the first processing unit or the second processing unit.

3. The apparatus according to claim 1, wherein a protocol of the network access authentication is a protocol specified by RFC5191.

4. An operation method of a terminal apparatus, comprising:
controlling a first processing unit to execute message processing as an authentication client for network access authentication;
controlling a second processing unit to execute message processing as an authentication relay between a network access authentication server and an authentication client in another terminal apparatus; and
controlling a determiner to choose one of the first processing unit and the second processing unit on how to process a message which is sent by the network access authentication server or the other terminal apparatus.

5. The method according to claim 4, further comprising holding information indicating a network access authentication state in the first processing unit, and
wherein the controlling the second processing unit includes determining based on the information and an analysis result of a message received from the network access authentication server or the other terminal apparatus whether the message is processed by the first processing unit or the second processing unit.

6. The method according to claim 4, wherein a protocol of the network access authentication is a protocol specified by RFC5191.

7. A computer-readable recording medium which stores thereon a program for controlling a computer to function as:
a first processing unit configured to execute message processing as an authentication client for network access authentication;
a second processing unit configured to execute message processing as an authentication relay between a network access authentication server and an authentication client in another terminal apparatus; and
a determiner configured to choose one of the first processing unit and the second processing unit on how to process a message which is sent by the network access authentication server or the other terminal apparatus.
